(19) United States
(12) Patent Application Publication
(10) Pub. No.: US 2017/0295312 A1
(43) Pub. Date: Oct. 12, 2017

(54) SAMPLE OBSERVATION APPARATUS

(71) Applicant: OLYMPUS CORPORATION, Tokyo (JP)

(72) Inventor: Yukinori TAKAHASHI, Tokyo (JP)

(73) Assignee: OLYMPUS CORPORATION, Tokyo (JP)

(21) Appl. No.: 15/465,119

(22) Filed: Mar. 21, 2017

(30) Foreign Application Priority Data
Apr. 11, 2016 (JP) 2016-079094

(51) Int. Cl. H04N 5/232; G02B 7/10; H04N 5/225; G02B 17/00

(52) U.S. Cl. CPC H04N 5/23212; G02B 17/008; G02B 7/10; H04N 5/2256

(57) ABSTRACT

A sample observation apparatus includes: an optical element configured to reflect light transmitted through a sample; a moving optical system configured to move in a direction along an optical axis to cause the light from the optical element to be image-formed on an image pickup surface of the image pickup device; and driving unit configured to cause the whole moving optical system to move along the optical axis. The optical element and the moving optical system form a telecentric optical system, and are configured to adjust a focus position by causing the moving optical system to move by the driving unit and configured so that, at the time of causing the moving optical system to move in the direction along the optical axis, an angle of view is constant.

### CROSS REFERENCE TO RELATED APPLICATION

This application claims the benefit of Japanese Application No.2016-079094 filed in Japan on Apr. 11, 2016, the contents of which are incorporated herein by this reference.

### BACKGROUND OF THE INVENTION

### 1. Field of the Invention

The present invention relates to a sample observation apparatus for observing a sample of cells or the like in a culture vessel.

### 2. Description of the Related Art

As for a sample observation apparatus provided with a driving mechanism and the like capable of causing an image pickup unit which includes an image pickup optical system, an image pickup device and the like to linearly move in each of two directions of an X axis and a Y axis orthogonal to each other and causing the image pickup unit to freely move within a plane parallel to an X-Y plane and configured to be able to automatically scan a whole image of a sample of cells or the like in a culture vessel and capable of arbitrarily observe a desired part of the sample of cells or the like in the culture vessel, various forms of sample observation apparatuses have been conventionally proposed, for example, by Japanese Patent Application Laid-Open Publication No. H5-232047, Japanese Patent Application Laid-Open Publication No. 2008-92882 and the like and put to practical use.

As an optical apparatus such as the sample observation apparatus of this kind, an optical apparatus provided with a so-called bending optical system configured to bend an optical axis of an image pickup optical system using a prism, a reflective mirror or the like to cause a light flux from an observation target subject to be image-formed on a surface different from a surface facing the subject, for example, various forms of observation apparatuses and image display apparatuses have been conventionally proposed and put to practice.

For example, an image display apparatus disclosed by Japanese Patent Application Laid-Open Publication No. 2015-143861 is configured to draw out a whole bending optical system to cause a real image which is image-formed by the bending optical system to be image-formed as an intermediate image between the bending optical system and a mirror optical system, and perform image formation and projection of a projected image with the intermediate image as an object image, on a screen using the mirror optical system which is spherical. The image display apparatus is configured to have a function of correcting out-of-focus at and around a center of an image and a function of correcting defocus of the whole projected image.

### SUMMARY OF THE INVENTION

A sample observation apparatus of an aspect of the present invention is a sample observation apparatus for observing a sample in a culture vessel, the culture vessel being arranged on a placing portion having a light transmitting portion, and the sample observation apparatus including: an optical element configured to reflect light transmitted through the sample; a moving optical system comprising an image pickup device and configured to move in a direction along an optical axis to cause the light from the optical element to be image-formed on an image pickup surface of the image pickup device; and driving means configured to cause the whole moving optical system to move along the optical axis of the moving optical system; wherein the optical element and the moving optical system form a telecentric optical system as a whole, and are configured to adjust a focus position by causing the moving optical system to move by the driving means and configured so that, at the time of causing the moving optical system to move in the direction along the optical axis, an angle of view is constant.

Benefit of the present invention will be further apparent from following detailed description.

### BRIEF DESCRIPTION OF THE DRAWINGS

FIG. 1 is a system configuration diagrams showing an outline of a whole configuration of a sample observation system which includes a sample observation apparatus according to one embodiment of the present invention;

FIG. 2 is an external perspective view showing external appearance of the sample observation apparatus of the one embodiment of the present invention;

FIG. 3 is an external perspective view showing a state in which a culture vessel (a culture flask) has been removed from the sample observation apparatus of FIG. 2;

FIG. 4 is an external perspective view showing an internal configuration of the sample observation apparatus of FIG. 2 with a lid of the sample observation apparatus removed;

FIG. 5 is a plan view of the sample observation apparatus of FIG. 2 seen from its upper side, with the lid of the sample observation apparatus removed;

FIG. 6 is a cross-sectional view along a [6]-[6] line in FIG. 5;

FIG. 7 is a cross-sectional view along a [7]-[7] line in FIG. 5;

FIG. 8 is a cross-sectional view along a [8]-[8] line in FIG. 5;

FIG. 9 is a cross-sectional view along a [9]-[9] line in FIG. 5;

FIG. 10 is an external perspective view mainly showing an upper side of a second moving member in the sample observation apparatus of FIG. 2;

FIG. 11 is an external perspective view mainly showing a back side of the second moving member in the sample observation apparatus of FIG. 2;

FIG. 12 is a plan view seen from the upper side of the second moving member in the sample observation apparatus of FIG. 2;

FIG. 13 is a cross-sectional view along a [13]-[13] line in FIG. 12;

FIG. 14 is a cross-sectional view along a [14]-[14] line in FIG. 5; and

FIG. 15 is a cross-sectional view showing a state at time of using the sample observation apparatus of FIG. 2 (corresponding to a section along the [8]-[8] line in FIG. 5).

### DETAILED DESCRIPTION OF THE PREFERRED EMBODIMENTS

The present invention will be described below by an embodiment shown in drawings. Each drawing used in the description below is schematic, and a dimensional relationship, reduced scale and the like of each member may be shown different for each component in order to show each component in a recognizable size on the drawing. Therefore, as for the number of components, shapes of the components, a ratio of sizes of the components, relative positional relationships among the respective components and the like described in each of the drawings, the present invention is not limited to the form shown in the drawings.

### Embodiment

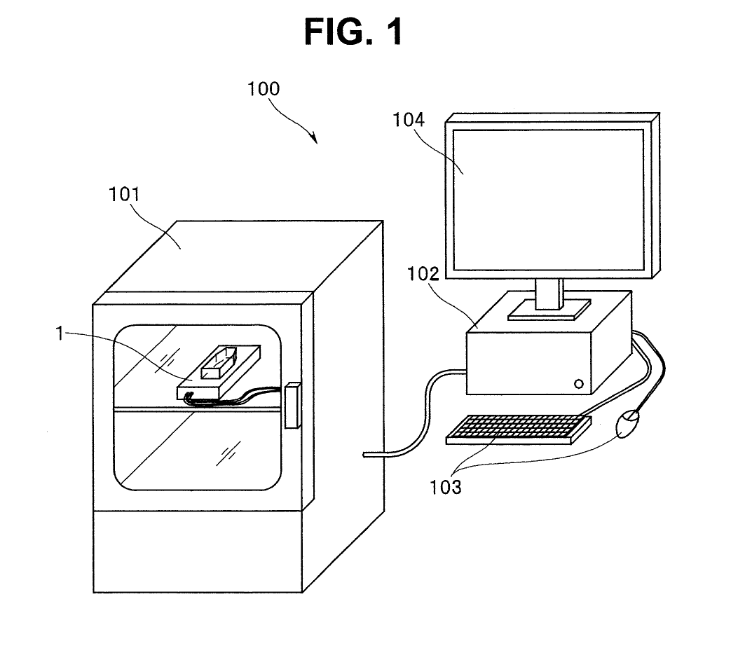

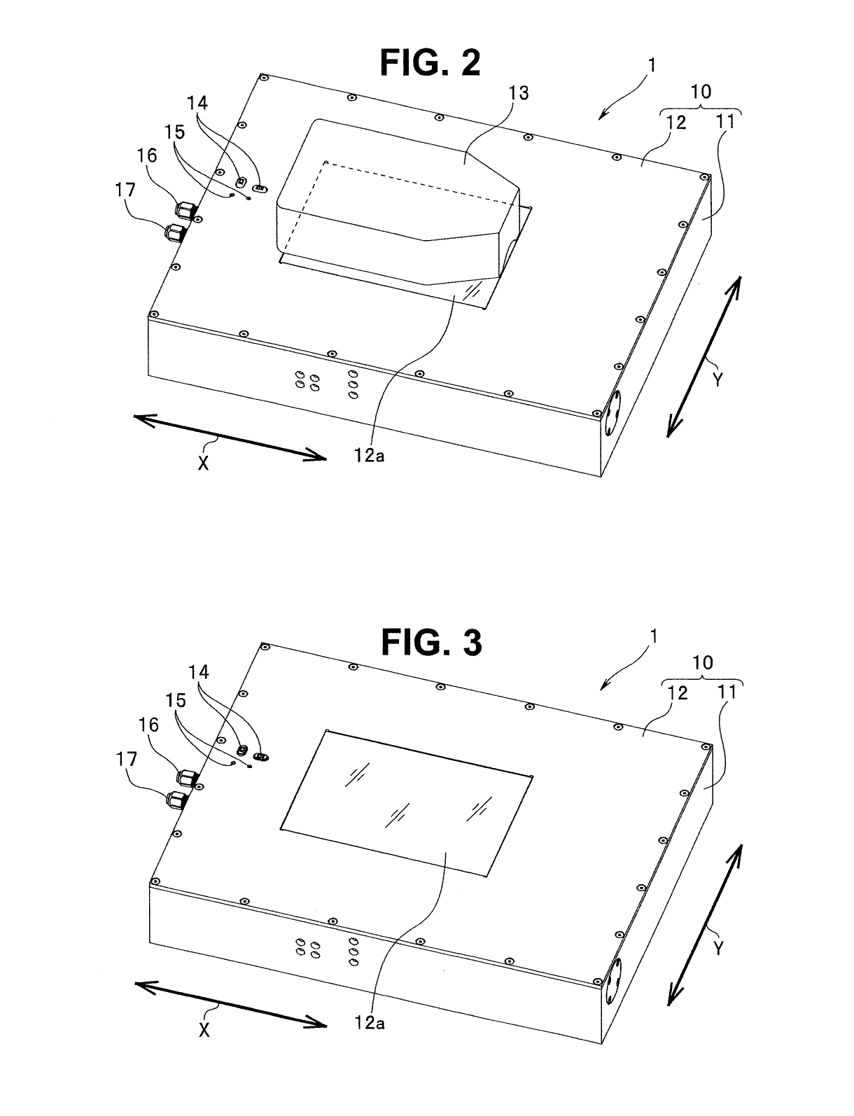

FIG. 1 is a system configuration diagrams showing an outline of a whole configuration of a sample observation system which includes a sample observation apparatus according to one embodiment of the present invention. FIG. 2 is an external perspective view showing external appearance of the sample observation apparatus of the present embodiment. FIG. 3 is an external perspective view showing a state in which a culture vessel (a culture flask) has been removed from the sample observation apparatus of FIG. 2.

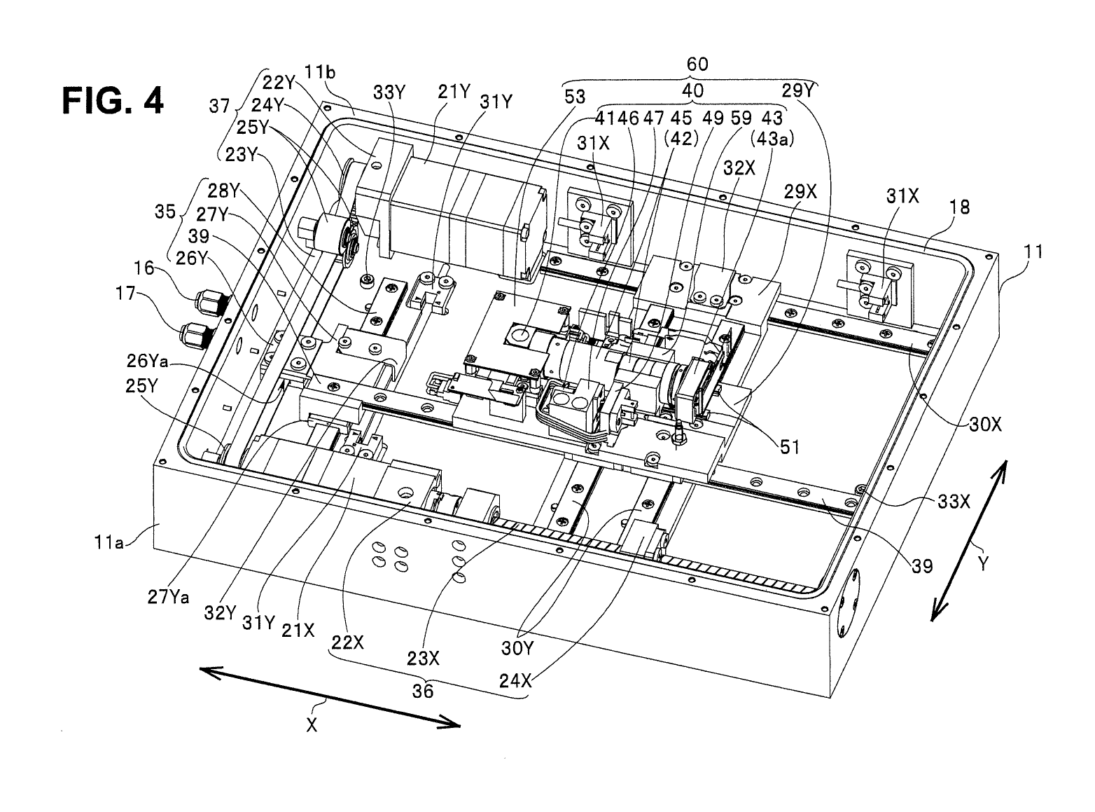

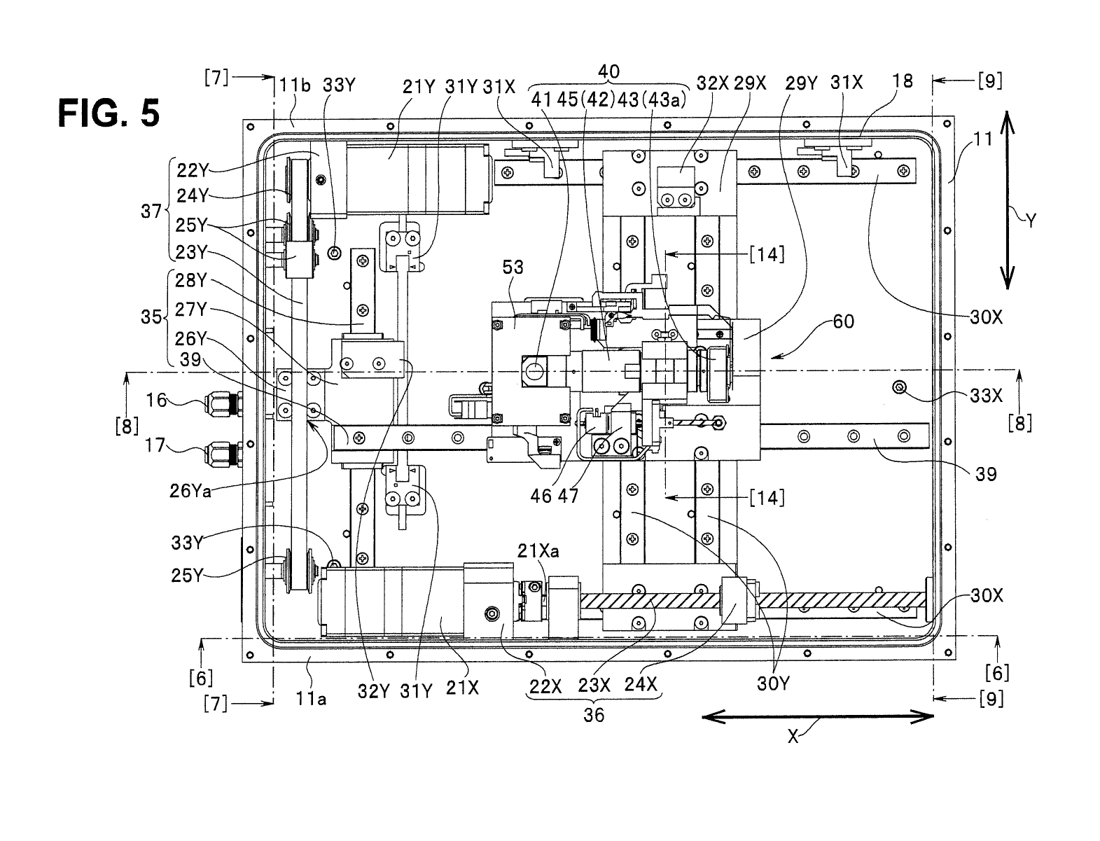

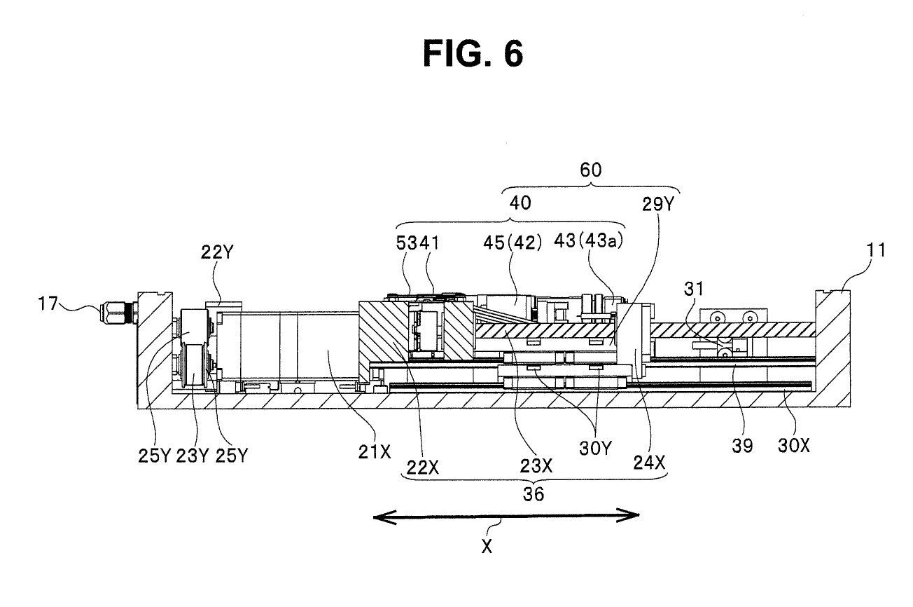

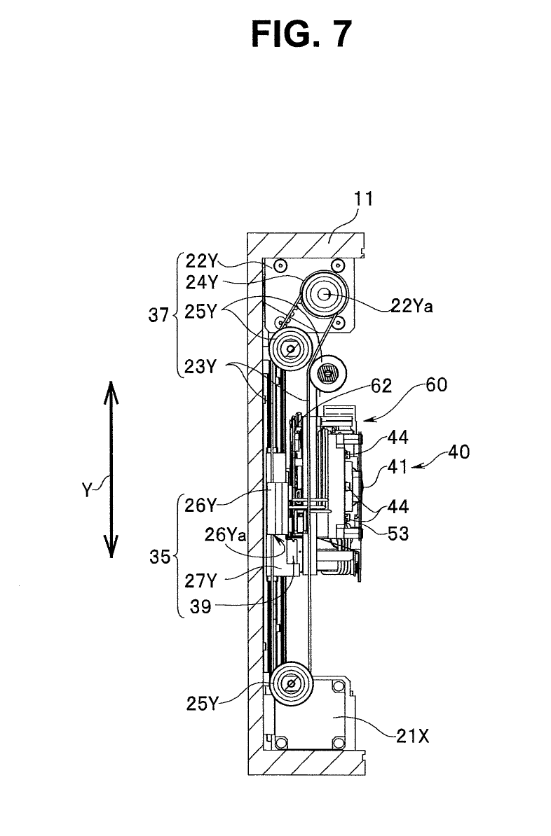

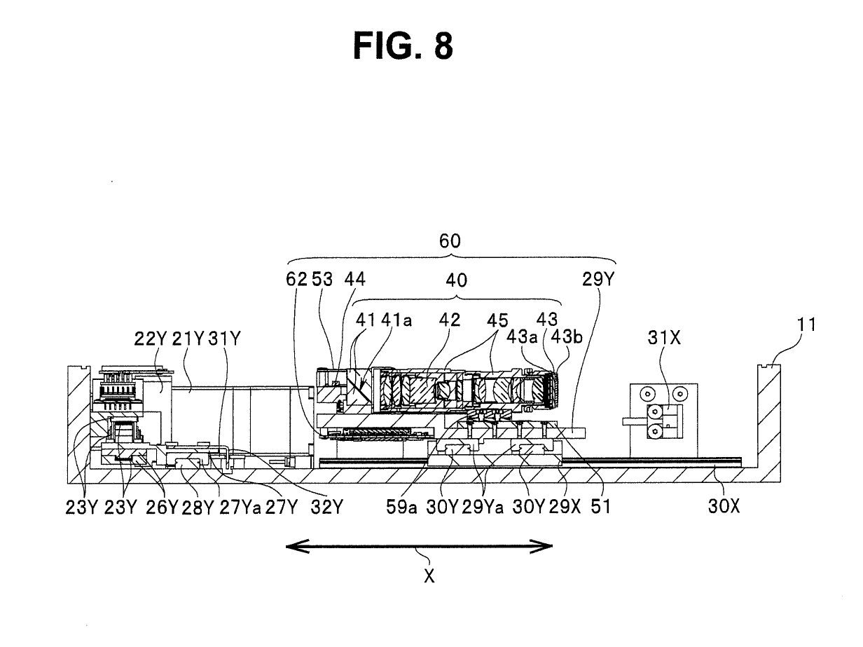

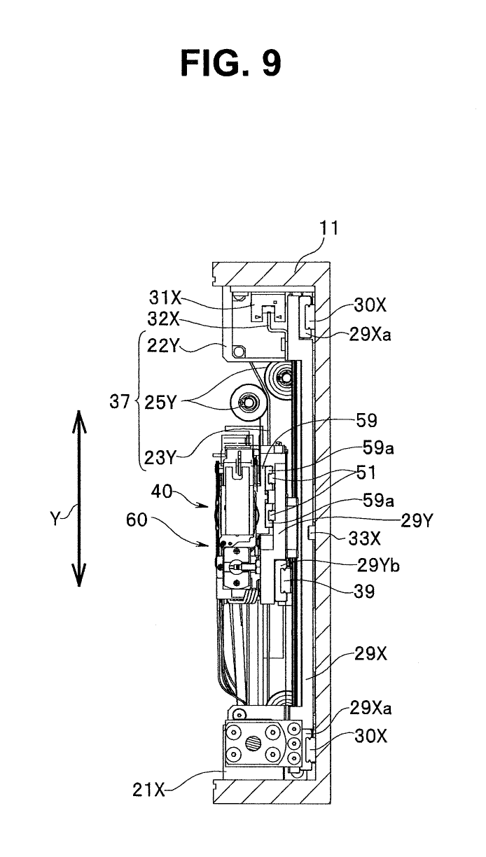

FIGS. 4 to 9 are diagrams showing an internal configuration of the sample observation apparatus of FIG. 2 with a lid of the sample observation apparatus removed. Among the figures, FIG. 4 is an external perspective view. FIG. 5 is a plan view seen from an upper side. FIG. 6 is a cross-sectional view along a [6]-[6] line in FIG. 5. FIG. 7 is a cross-sectional view along a [7]-[7] line in FIG. 5. FIG. 8 is a cross-sectional view along a [8]-[8] line in FIG. 5. FIG. 9 is a cross-sectional view along a [9]-[9] line in FIG. 5.

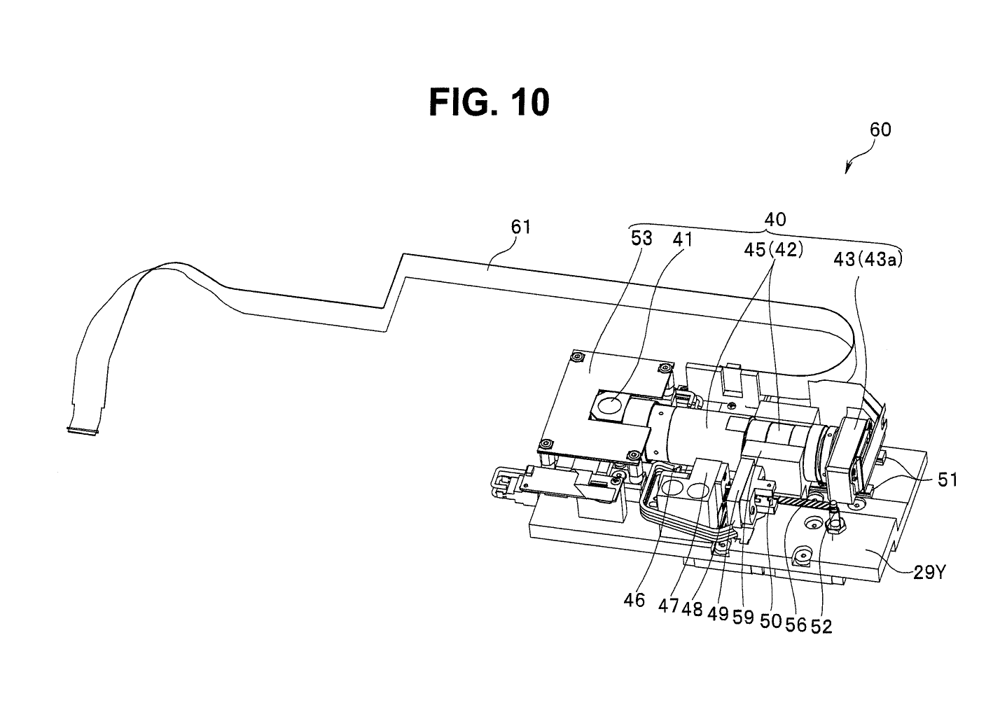

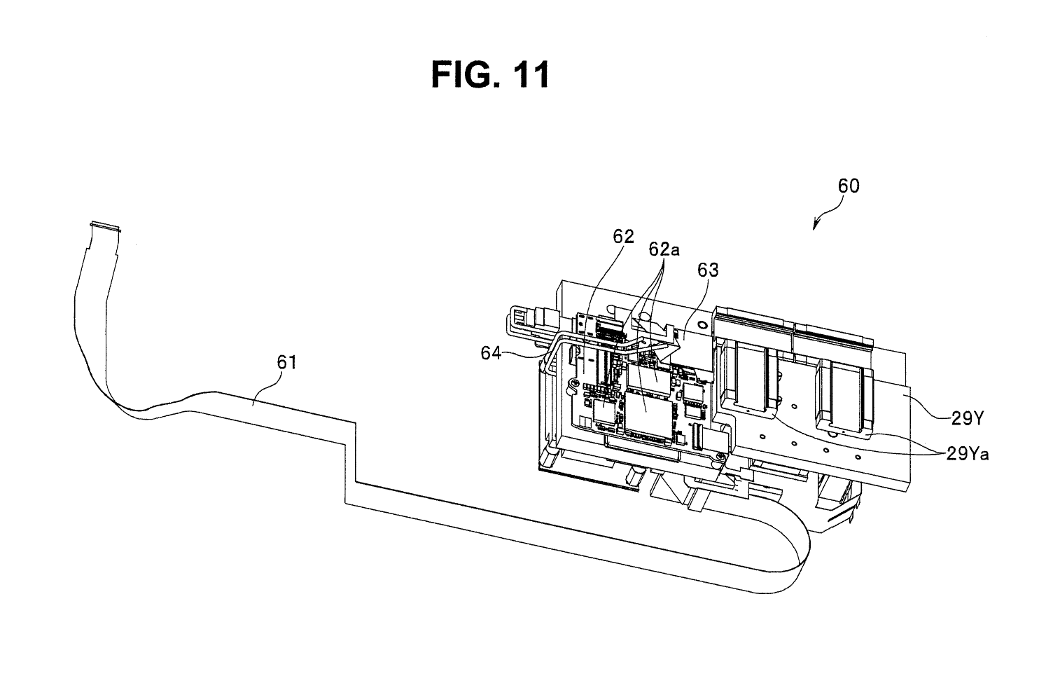

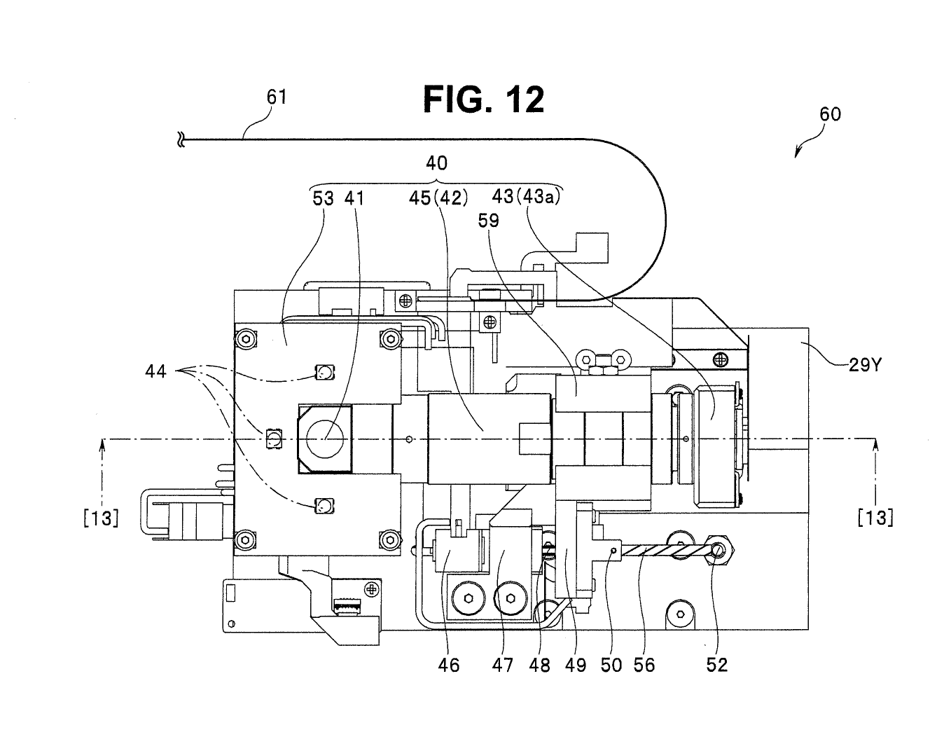

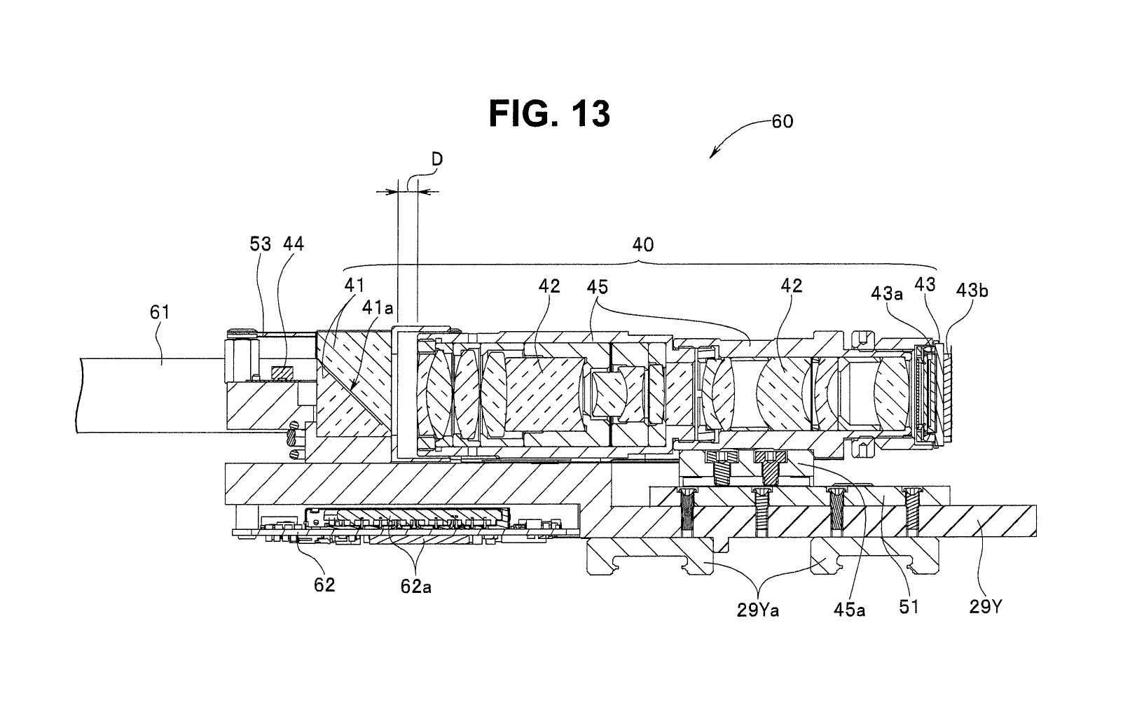

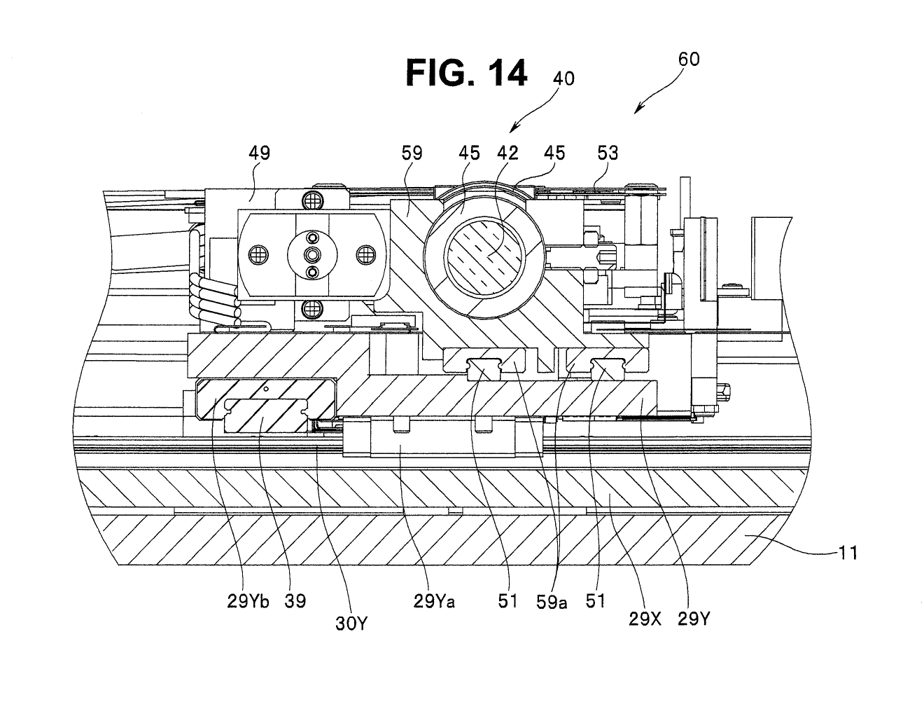

FIGS. 10 to 14 are diagrams showing only a second moving member taken out from the sample observation apparatus of FIG. 2. Among the figures, FIG. 10 is an external perspective view mainly showing the upper side. FIG. 11 is an external perspective view mainly showing a back side. FIG. 12 is a plan view seen from the upper side. FIG. 13 is a cross-sectional view along a [13]-[13] line in FIG. 12. FIG. 14 is an enlarged cross-sectional view of a main part which is enlarged to mainly show a moving optical system holding structure. Note that FIG. 14 is a cross-sectional view along a [14]-[14] line in FIG. 5.

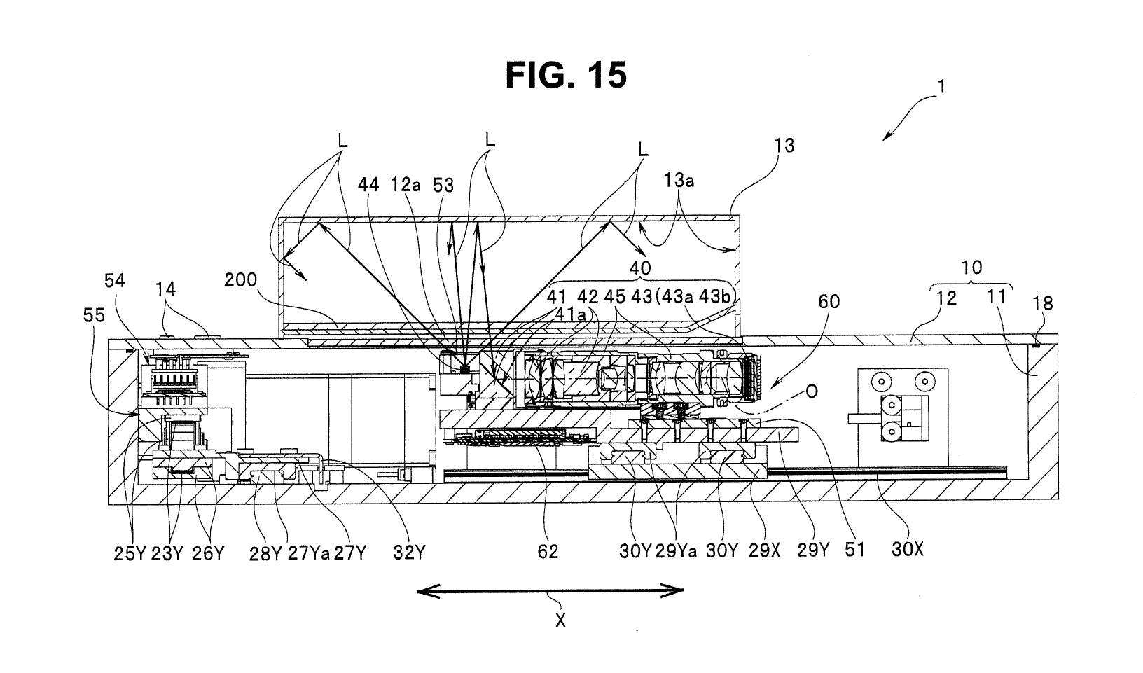

FIG. 15 is a cross-sectional view showing a state at time of a culture vessel in the sample observation apparatus of the present embodiment for use. Note that FIG. 15 corresponds to a section along the [8]-[8] line in FIG. 5 in the sample observation apparatus in the state in which the culture vessel is fitted.

First, before describing a detailed configuration of the sample observation apparatus of the one embodiment of the present invention, an outline of a whole configuration of the sample observation system which includes the sample observation apparatus of the present embodiment will be described below mainly with use of FIG. 1.

A sample observation system 100 which includes a sample observation apparatus 1 of the present embodiment is mainly configured with the sample observation apparatus 1, an incubator 101, a control device 102, an input device 103, a display device 104 and the like.

The sample observation apparatus 1 of the present embodiment is used in a state of being stored and placed inside the incubator 101. The incubator 101 is an apparatus having a function of keeping temperature constant. It is assumed that an incubator that is commonly and widely used conventionally is applied as the incubator 101 though various forms of incubators exist, and description of a detailed configuration of the incubator 101 will be omitted.

The control device 102 is electrically connected to the sample observation apparatus 1 of the present embodiment, for example, via wired connection means (USB (universal serial bus) connection or the like) such as a connecting cable or wireless connection means not shown. The control device 102 is a device for controlling an operation of the sample observation apparatus 1, receiving image data acquired by the sample observation apparatus 1, storing the received image data into a storage medium, performing various kinds of image signal processing such as analysis for the received image data, and supplying power to the sample observation apparatus 1. As the control device 102, for example, a small-size personal computer that is widely and commonly used can be applied. It is possible to operate the computer or the like by appropriately preparing various kinds of control programs compatible with the computer, for that purpose.

Note that power supply to the sample observation apparatus 1 is not limited to power supply means via the control device 102, and it is possible to supply power from a commercial power supply provided outside the incubator 101 using a power cable not shown or supply power from a storage battery or the like placed inside or outside the incubator 101.

To the control device 102, the input device 103, the display device 104 and the like as peripheral equipment of the control device 102 are electrically connected. The input device 103 is a device for inputting an instruction to the control device 102 by a user. As a form of the input device 103, for example, a pointing device such as a mouse, a track ball and a joystick is given in addition to a key board. The user can input control instructions to the control device 102 and input instructions for various kinds of signal processing using the input device 103.

The display device 104 is a device for visually displaying various kinds of displays based on a control program operated by the control device 102 and images and the like based on image data and the like received by the control device 102. As the display device 104, a liquid crystal display monitor or the like that is widely and commonly used can be applied.

Next, a detailed configuration of the sample observation apparatus 1 of the present embodiment will be described below with use of FIGS. 2 to 14.

The sample observation apparatus 1 of the present embodiment is a sample observation apparatus provided with a driving mechanism capable of causing an image pickup unit 40 or the like provided inside to linearly move in two directions of an X axis and a Y axis orthogonal to each other and causing the image pickup unit 40 or the like to freely move in a plane parallel to an X-Y plane. The sample observation apparatus 1 is configured so that a culture vessel 13 is arranged on a placing portion having a light transmitting portion 12a to observe a sample in the culture vessel 13.

Note that, in the description below, a direction along a long side of a case 10 (to be described later) in the sample observation apparatus 1 will be referred to as the X axis, and a direction along the X axis will be referred to as a first direction, as shown in FIG. 2 and the like. Further, a direction along a short side of the case 10 and orthogonal to the X axis will be referred to as the Y axis, and a direction along the Y axis will be referred to as a second direction.

Therefore, the sample observation apparatus 1 of the present embodiment is configured with the case 10 in a rectangular parallelepiped shape which is sealed and the culture vessel 13 placed on one face of the case 10 as shown in FIGS. 2 and 3. Note that, since FIG. 3 shows a state in which the culture vessel 13 has been removed, the culture vessel 13 is not shown in FIG. 3.

The case 10 is configured with a chassis 11 having an opening on one face and a lid 12 watertightly covering the opening of the chassis 11. Various kinds of component members of the sample observation apparatus 1 are stored and arranged inside the chassis 11, though details will be described later. Further, on an outer wall surface on one side face (on a front side) of the chassis 11, a plurality of connection connectors 16, 17 are arranged. The plurality of connection connectors 16, 17 are, for example, connectors corresponding to the power cable for supplying power to the sample observation apparatus 1, a signal transmission cable (for example, a USB cable) for transmitting various kinds of signals and the like including control signals to the sample observation apparatus 1 and data signals outputted from the sample observation apparatus 1, and the like.

The plurality of connection connectors 16, 17 are arranged inside the chassis 11 and are respectively connected to each corresponding electric board (not shown in FIG. 4 and the like; see reference numeral 55 in FIG. 15 to be described later). On the electric board (55 in FIG. 15), for example, a power supply circuit, a communication circuit and the like are implemented.

Note that, in the chassis 11, the wall surface on one side face where the plurality of connection connectors 16, 17 are arranged will be referred to as a front wall surface. In the description below, two side walls provided orthogonal to the front wall surface and arranged facing each other will be referred to as a first side wall 11a and a second side wall 11b, respectively (see FIG. 4). Further, a face facing the opening of the chassis 11 will be referred to as a bottom face.

The lid 12 is configured having the light transmitting portion 12a and is a placing portion for placing the culture vessel 13. The light transmitting portion 12a is formed by a window portion which is, for example, a rectangular-shaped through hole, and a transparent thin-plate member having light transmissivity, which is fittedly arranged in the window portion and formed with glass material, material made of resin, or the like.

The culture vessel 13 is a box-shaped vessel for making a medium and culturing a sample of a microorganism such as bacteria, cells or the like. When the sample observation apparatus 1 is used, the culture vessel 13 is placed on the light transmitting portion 12a of the lid 12 of the case 10.

A side of the culture vessel 13, which faces the light transmitting portion 12a when the culture vessel 13 is placed on the light transmitting portion 12a, that is, a bottom face side of the culture vessel 13 is formed in a flat plate shape, and the flat-plate-shaped bottom is formed as a transparent thin plate. Surfaces of faces of the culture vessel 13 other than the bottom face are also formed flat, so that reflective surfaces capable of reflecting light are formed. The reflective surfaces receive illumination light that is emitted from an illumination light source provided inside the case 10 of the sample observation apparatus 1 and comes into the culture vessel 13 via the light transmitting portion 12a, and reflect the illumination light. Thereby, the sample of cells or the like within the flat-plate-shaped bottom face of the culture vessel 13 is illuminated by the illumination light from the reflected surfaces. Therefore, in the sample observation apparatus 1 is configured so that it is possible to observe the sample of cells or the like in the culture vessel 13 with transmitted light.

Further, the lid 12 is provided with a plurality of operation members 14 and a plurality of state indicating portions 15. The plurality of operation members 14 are operation switches and the like for performing positional adjustment and the like of driven units (the image pickup unit 40 and the like; details are to be described later) in the sample observation apparatus 1, inside the case 10 by manual operations, for example, before placing the sample observation apparatus 1 in the incubator 101. The plurality of state indicating portions 15 are members provided to indicate which operation member has been operated, for example, by being lit up when one of the plurality of operation members 14 is operated. Therefore, the plurality of state indicating portions 15 are provided near the plurality of operation members 14, respectively. As the plurality of state indicating portions 15, for example, illuminant bodies or the like such as LEDs (light emitting diodes) are applied.

The plurality of operation members 14 and the plurality of state indicating portions 15 are arranged inside the chassis 11 and are respectively connected to each corresponding electric board (not shown in FIG. 4 and the like; see reference numeral 54 in FIG. 15 to be described later). On the electric substrate (54; FIG. 15), a state indicating member (LED) driving circuit and the like are implemented in addition to, for example, switching members configured to receive operation inputs of the operation members and a signal processing circuit configured to process the input signals.

The case 10 is configured having a sealed structure, that is, a watertight structure. Thus, the chassis 11 is provided with a sealing member 18 as shown in FIG. 4 and the like. The sealing member 18 is arranged along a peripheral portion of the opening of the chassis 11 at a part where an internal surface of the lid 12 is closely attached when the lid 12 is arranged on the chassis 11 to cover the opening of the chassis 11. When the lid 12 is arranged on the chassis 11, the lid 12 watertightly covers the opening of the chassis 11 by the sealing member 18 being closely attached to the internal surface of the lid 12. The watertight structure of the case 10 is configured by such a form.

Inside the case 10 (the chassis 11), a driven unit 60 which includes the image pickup unit 40 and the like, and a driving mechanism for causing the driven unit 60 to freely move within the plane parallel to the X-Y plane, and the like are arranged as shown in FIGS. 4 to 9 and the like.

Though details will be described later, the driven unit 60 is configured including an image pickup optical system (41, 42, 45 and the like) and a driving mechanism (46, 47, 49, 59 and the like) for the image pickup optical system; the image pickup unit 40 configured including an image pickup portion 43 including an image pickup device 43a and light source portions 44 (see FIG. 7), an electric substrate 62 (see FIG. 8) on which driving circuits for the image pickup portion 43 and the light source portions 44 are implemented, and the like; and a second table 29Y which is a moving member mounted with the image pickup unit 40 and is a second moving member to be described later. Note that a detailed configuration of the driven unit 60 will be described later with use of FIGS. 10 to 13 and the like.

Inside the case 10 (the chassis 11), the driving mechanism for causing the driven unit 60 to move within the plane parallel to the X-Y plane is configured with: first guide rails 30X (first guide portions, first guide means); second guide rails 30Y (second guide portions, second guide means); a first table 29X (a first moving member), the second table 29Y (a second moving member), a first driving motor 21X; a second driving motor 21Y; a transmission mechanism 35; first driving force transmitting means 36; second driving force transmitting means 37; first position detecting means (31X, 32X) and second position detecting means (31Y, 32Y); first position restricting means 33X and second position restricting means 33Y; and the like.

The first guide rails 30X are arranged to extend along an X axis direction, which is a first direction. The first guide rails 30X are first guide portions configured to guide movement of the first table 29X in the X axis direction and are first guide means. A plurality of first guide rails 30X are provided inside the chassis 11. In the present embodiment, an example where two first guide rails 30X are provided is shown. In this case, one of the two first guide rails 30X is provided at a position adjoining the side wall 11a within a predetermined range along the side wall 11a. Further, the other of the two first guide rails 30X is provided at a position adjoining the side wall 11b within a predetermined range along the side wall 11b.

Note that, inside the chassis 11, the first driving motor 21X is provided at a position adjoining the side wall 11a, along the side wall 11a as described later. Similarly, inside the chassis 11, the second driving motor 21Y is provided at a position adjoining the side wall 11b, along the side wall 11b. Therefore, the two first guide rails 30X are positioned at positions adjoining the side walls 11a and 11b, respectively, other than the positions adjoining the side walls 11a and 11b where the first driving motor 21X and the second driving motor 21Y are arranged. Thereby, the first driving motor 21X and one of the first guide rails 30X are arranged side by side so that their respective longitudinal directions are linearly along the side wall 11a. Similarly, the second driving motor 21Y and the other of the first guide rails 30X are arranged side by side so that their respective longitudinal directions are linearly along the side wall 11b.

The first table 29X is a first moving member configured to move in the X axis direction along the first guide rails 30X by being guided by the first guide rails 30X. The first table 29X is driven by rotational driving force of the first driving motor 21X to be described later. Therefore, first rail holding portions 29Xa configured to slidably hold the first guide rails 30X are provided on each undersurface side of both end portions of the first table 29X in the Y axis direction as shown in FIG. 9. The first rail holding portions 29Xa are arranged to extend in the X axis direction. Each first rail holding portion 29Xa is formed having a groove-shaped portion in a form of surrounding a width direction (a direction orthogonal to an axial direction) of the first guide rail 30X. Due to such a configuration, the first table 29X is configured to be guided by the first guide rails 30X to move only in the X axis direction along the first guide rails 30X.

The second guide rails 30Y are arranged to extend along a second direction vertical to the X axis direction (a Y axis direction). The second guide rails 30Y are second guide portions configured to guide movement of the second table 29Y in the Y axis direction and are second guide means. A plurality of second guide rails 30Y are provided in a form of being placed on the first table 29X inside the chassis 11. In the present embodiment, an example where two second guide rails 30Y are provided is shown. In this case, the two second guide rails 30Y are arranged side by side at a predetermined interval in the X axis direction on the first table 29X.

The second table 29Y is a second moving member configured to move in the Y axis direction along the second guide rails 30Y by being guided by the second guide rails 30Y. Further, the second table 29Y is configured to move in the X axis direction also together with the first table 29X. Therefore, second rail holding portions 29Ya configured to slidably hold the two second guide rails 30Y, respectively, are provided on an undersurface side of the second table 29Y as shown in FIG. 8. The second rail holding portions 29Ya are arranged to extend in the Y axis direction. Each second rail holding portion 29Ya is formed having a groove-shaped portion in a form of surrounding a width direction (a direction orthogonal to an axial direction) of the second guide rail 30Y. Due to such a configuration, the second table 29Y moves in the Y axis direction along the second guide rails 30Y by being guided by the second guide rails 30Y and, when the first table 29X is guided by the first guide rails 30X to move in the X axis direction along the first guide rails 30X, moves in the same direction (the X axis direction) together with the first table 29X.

As described above, the second table 29Y is mounted with the image pickup unit 40 including the image pickup portion 43, and the like. Thereby, the second table 29Y functions as a part of the driven unit 60.

The first driving motor 21X is a driving motor having a first rotating shaft 21Xa (see FIG. 5) configured to output rotational force for causing the first table 29X to be moved and driven in the X axis direction. As described above, the first driving motor 21X is provided adjoining the first side wall 11a of the case 10 (the chassis 11). In this case, the first rotating shaft 21Xa is arranged parallel to the first guide rails 30X. A configuration is made so that the rotational driving force outputted from the first rotating shaft 21Xa of the first driving motor 21X is transmitted to the first table 29X via the first driving force transmitting means 36 to cause the first table 29X to move in the X axis direction.

The first driving force transmitting means 36 is a driving force transmitting mechanism configured to transmit a rotational output from the first driving motor 21X to the first table 29X (the first moving member). The first driving force transmitting means 36 is configured with first decelerating means 22X, a feed screw 23X and a feed nut 24X.

The first decelerating means 22X is a component unit internally having a gear train or the like configured to decelerate in response to a rotational output from the first rotating shaft 21Xa of the first driving motor 21X. As for a configuration itself of the first decelerating means 22X, it is assumed that a configuration similar to the configuration of conventionally well-known power decelerating means is applied, and detailed description of the configuration will be omitted.

The feed screw 23X is a rod-shaped member configured to rotate in response to a rotational output from the first decelerating means 22X. A proximal end of the feed screw 23X is coupled with the first decelerating means 22X. Further, the other end of the feed screw 23X is rotationally and pivotally supported relative to a fixation portion on an internal wall surface of the chassis 11 with rotation being allowed.

The feed nut 24X is a component portion internally provided with a nut portion to be screwed with the feed screw 23X and fixed to the first table 29X. Due to the configuration, when the feed screw 23X rotates in response to a rotational output of the first driving motor 21X, the feed nut 24X moves in the direction along the X axis by action of the nut portion screwed with the feed screw 23X. Simultaneously, the first table 29X also moves in the same direction. In this case, a rotation direction of the feed nut 24X is controlled by controlling a rotation direction of the first driving motor 21X, and, thereby, it is possible to control forward and backward movement directions of the first table 29X in the direction along the X axis.

That is, the first table 29X moves in a direction parallel to the first rotating shaft 21Xa of the first driving motor 21X (the X axis direction) by a feed screw driving system using the first driving motor 21X, the feed screw 23X, the feed nut 24X and the like.

The second driving motor 21Y is a driving motor having a second rotating shaft 21Ya (see FIG. 7) configured to output rotational force for causing the second table 29Y to be moved and driven in the Y axis direction. The second driving motor 21Y is provided adjoining the second side wall 11b facing the first side wall 11a of the case 10 (the chassis 11). In this case, the second rotating shaft 22Ya is arranged to be parallel to the first guide rails 30X and the first rotating shaft 21Xa.

A configuration is made so that the rotational driving force outputted from the second rotating shaft 21Ya of the second driving motor 21Y is transmitted to the second table 29Y mounted with the image pickup unit 40 including the image pickup portion 43, and the like, via the second driving force transmitting means 37 and the transmission mechanism 35 to cause the second table 29Y to move in the Y axis direction.

In other words, the second table 29Y moves in the Y axis direction via the transmission mechanism 35 included in the second driving force transmitting means 37 configured to transmit the rotational force from the second driving motor 21Y.

The second driving force transmitting means 37 is a driving force transmitting mechanism configured to transmit a rotational output from the second driving motor 21Y to the second table 29Y (the second moving member) mounted with the image pickup portion 43. The second driving force transmitting means 37 is configured including a second decelerating means 22Y, a driving belt 23Y, a plurality of pulleys 24Y and 25Y, and the transmission mechanism 35.

The second decelerating means 22Y is a component unit internally having a gear train or the like configured to decelerate in response to a rotational output from the second rotating shaft 21Ya of the second driving motor 21Y, and is a component unit substantially similar to the first decelerating means 22X. Therefore, as for a configuration itself of the second decelerating means 22Y also, it is assumed that a configuration similar to the configuration of conventionally well-known power decelerating means is applied, and detailed description of the configuration will be omitted.

The driving belt 23Y and the plurality of pulleys 24Y and 25Y are component members configured to receive a rotational output from the second decelerating means 22Y and convert the rotational output to a movement output in the Y axis direction. The pulleys 24Y among the plurality of pulleys 24Y and 25Y are coaxially and fixedly arranged on a shaft member configured to output the rotational output from the second decelerating means 22Y. The driving belt 23Y is stretched over each of the pulleys 24Y and 25Y so that movement of the driving belt 23Y which moves in response to a rotational output of the second driving motor 21Y is guided, and positioning of the driving belt 23Y and the like are performed. Since the mechanism for converting a rotational output of a driving motor by a driving belt is conventionally well-known, further detailed description will be omitted.

A part of the transmission mechanism 35 is fixedly arranged at a predetermined part of the driving belt 23Y. Due to the configuration, the transmission mechanism 35 is configured to, when the driving belt 23Y moves in the direction along the Y axis in response to the rotational output of the second driving motor 21Y, move in the same direction. In this case, it is possible to, by controlling a rotation direction of the second driving motor 21Y, control forward and backward movement directions of the driving belt 23Y in a feeding direction and forward and backward movement directions of the transmission mechanism 35 in the direction along the Y axis.

That is, the transmission mechanism 35 moves in a direction orthogonal to the second rotating shaft 21Ya of the second driving motor 21Y (the Y axis direction) by a belt driving system using the second driving motor 21Y, the driving belt 23Y and the like.

The transmission mechanism 35 is configured with a third guide rail 28Y (a third guide portion, third guide means), a third moving member constituted by a belt holding portion 26Y and a third table 27Y, and a coupling member 39.

The third guide rail 28Y is arranged parallel to the second guide rails 30Y, and the third guide rail 28Y is a third guide portion configured to guide movement of the third moving members (26Y and 27Y) in the Y axis direction and is third guide means.

The third moving member is a moving member configured to move in the Y axis direction along the third guide rail 28Y in response to rotational force from the second driving motor 21Y. The third moving member is configured with the belt holding portion 26Y and the third table 27Y. The belt holding portion 26Y is a component member fixed to a predetermined part of the driving belt 23Y (a fixation part indicated by reference symbol 26Ya in FIG. 4). The third table 27Y is a moving member configured to move in the Y axis direction along the third guide rail 28Y by being guided by the third guide rail 28Y. Therefore, a third rail holding portion 27Ya configured to slidably hold the third guide rail 28Y is provided on an undersurface side of the third table 27Y as shown in FIG. 8. The third rail holding portion 27Ya is arranged to extend in the Y axis direction. The third rail holding portion 27Ya is formed having a groove-shaped portion in a form of surrounding a width direction (a direction orthogonal to an axial direction) of the third guide rail 28Y. Due to such a configuration, the third table 27Y moves in the Y axis direction along the third guide rail 28Y by being guided by the third guide rail 28Y.

The belt holding portion 26Y is fixed to the third table 27Y. As described above, the belt holding portion 26Y is fixed at the fixation part 26Ya of the driving belt 23Y. Therefore, due to the configuration, when the driving belt 23Y moves in the direction along the Y axis in response to a rotational output of the second driving motor 21Y, the third table 27Y also moves in the same direction.

The coupling member 39 is a member configured to couple the third table 27Y of the third moving member with the second table 29Y mounted with the image pickup unit 40 including the image pickup portion 43, and the like. One end of the coupling member 39 is fixed to the third table 27Y, and the second table 29Y is held on the other end side of the coupling member 39 in a state of being movable in the X axis direction (see FIG. 6 and the like).

As described above, (the third table 27Y of) the third moving member and the second table 29Y are coupled by the coupling member 39. Therefore, when the third moving member (26Y, 27Y) moves along the third guide rail 28Y based on an output from the second driving motor 21Y, the second table 29Y moves in the Y axis direction along the second guide rails 30Y in conjunction with the movement of the third moving member (26Y, 27Y) in the Y axis direction along the third guide rail 28Y.

The first position detecting means is a component portion provided to detect both end positions of a movement range of the first table 29X in the X axis direction and control the movement range of the first table 29X in the X axis direction. The first position detecting means is configured with a pair of first position detecting sensors 31X and a first light shielding blade 32X. The paired first position detecting sensors 31X are arranged on an internal wall surface of the second side wall 11b with a predetermined interval between them in the X axis direction. In the present embodiment, an example of applying detecting elements, for example, so-called transparent type photo interrupters as the pair of first position detecting sensors 31X is shown. The first light shielding blade 32X is arranged on the first table 29X. In this case, the first light shielding blade 32X is arranged at a position which corresponds to each of the paired first position detecting sensors 31X when the first table 29X moves in the X axis direction (see FIG. 4 and the like).

The first position restricting means 33X are members provided to restrict movement of the first table 29X in the X axis direction to be within a predetermined range. The first position restricting means 33X are provided at positions where the first table 29X comes into contact with the first position restricting means 33X when moving in the X axis direction. That is, the first position restricting means 33X are provided at two positions: a position where the first table 29X comes into contact when moving in one direction in the X axis direction and a position where the first table 29X comes into contact when moving in the other direction. Thereby, the movement range of the first table 29X in the X axis direction is restricted. In the present embodiment, an example of providing, for example, projection-shaped members provided in a state of projecting toward an inside of the chassis 11 (that is, upward) from the bottom face of the chassis 11 as a specific form of the first position restricting means 33X is shown (see FIG. 4 and the like).

The second position detecting means is a component portion provided to detect both end positions of a movement range of the third table 27Y in the Y axis direction and control the movement range of the third table 27Y in the Y axis direction. The second position detecting means is configured with a pair of second position detecting sensors 31Y and a second light shielding blade 32Y. The paired second position detecting sensors 31Y are arranged at positions near the third guide rail 28Y on the bottom face of the chassis 11 with a predetermined interval between them in the Y axis direction along the third guide rail 28Y. In the present embodiment, an example of applying detecting elements, for example, so-called transparent type photo interrupters as the pair of second position detecting sensors 31Y is shown. The second light shielding blade 32Y is arranged on the third table 27Y. In this case, the second light shielding blade 32Y is arranged at a position which corresponds to each of the paired second position detecting sensors 31Y when the third table 27Y moves in the Y axis direction (see FIG. 4 and the like).

The second position restricting means 33Y are members provided to restrict movement of the third table 27Y in the Y axis direction to be within a predetermined range. The second position restricting means 33Y are provided at positions where the third table 27Y comes into contact with the second position restricting means 33Y when moving in the Y axis direction. That is, the second position restricting means 33Y are provided at two positions: a position where the third table 27Y comes into contact when moving in one direction in the Y axis direction and a position where the third table 27Y comes into contact when moving in the other direction. Thereby, the movement range of the third table 27Y in the Y axis direction is restricted. In the present embodiment, an example of providing, for example, projection-shaped members provided in a state of projecting toward an inside of the chassis 11 (that is, upward) from the bottom face of the chassis 11 as a specific form of the second position restricting means 33Y is shown (see FIG. 4 and the like).

Next, a detailed configuration of the driven unit 60 will be described below with use of FIGS. 10 to 15 and the like.

As described above, the driven unit 60 is configured including the image pickup unit 40 and the second table 29Y which is a second moving member mounted with the image pickup unit 40.

The image pickup unit 40 is configured having a prism 41 (an optical element), a moving optical system (42, 45) including the image pickup portion 43, driving means (46 to 52, 59) which is a driving mechanism for the moving optical system, the light source portions 44, the electric substrate 62 and the like.

The prism 41 is an optical element having a reflective surface 41a configured to reflect light transmitted through a sample in the culture vessel 13. That is, the prism 41 in the present embodiment has a function of receiving the light transmitted through the sample in the culture vessel 13 placed on a predetermined part (the light transmitting portion 12a) on the lid 12 of the case 10 and bending an optical path of the light at an angle of 90 degrees to reflect the light in a predetermined direction, that is, toward a light receiving surface (not shown) of the image pickup device 43a. The prism 41 has a function of only reflecting light, and a member which does not bend the light, that is, which does not have a lens effect is applied. The prism 41 is fixedly arranged on the second table 29Y.

Though an example of using a prism is given as a form of the optical element having a reflective surface in the present embodiment, for example, a configuration example of applying a reflective mirror is also conceivable in addition to the form.

The moving optical system (42, 45, 43) is a component unit configured to be movable in a direction along an optical axis O to cause light from the prism 41 (the optical element) to be image-formed on the light receiving surface of the image pickup device 43a. Note that, in the present embodiment, the optical axis O of the moving optical system is arranged to be in the direction along the X axis. Therefore, the moving optical system is configured to be able to move forward and backward in the X axis direction.

The moving optical system is a component unit obtained by integrally combining an optical portion obtained by integrally combining a plurality of optical lenses 42 and a plurality of lens holding members 45 configured to hold the plurality of optical lenses 42, and the image pickup portion 43 including the image pickup device 43a, the image pickup substrate 43b and the like.

Note that a component portion configured with the prism 41, the plurality of optical lenses 42 and the plurality of lens holding member 45 will be referred to as an image pickup optical system. The image pickup optical system configured with the prism 41 (the optical element) and the moving optical system forms a telecentric optical system as a whole.

The moving optical system (42, 45, 43) is arranged in a state of being movable in the X axis direction on the second table 29Y. Therefore, a plurality of (two in the present embodiment) focus rails 51, which are guide means configured to guide movement of the moving optical system in the X axis direction, are provided on the second table 29Y. The focus rails 51 are arranged to extend along the X axis direction on the second table 29Y.

Correspondingly, the moving optical system is held by a moving optical system holding portion 59 having focus rail holding portions 59a configured to slidably hold the focus rails 51 (see FIGS. 9 and 14).

The moving optical system holding portion 59 is a component member constituting a part of the driving mechanism (to be described later in detail) of the moving optical system. The focus rail holding portions 59a are fixedly arranged on an undersurface side of the moving optical system holding portion 59. Each focus rail holding portions 59a is formed having a groove-shaped portion in a form of surrounding a width direction (a direction orthogonal to an axial direction) of the focus rails 51. Two focus rail holding portions 59a are provided, corresponding to the two focus rails 51. Due to such a configuration, the moving optical system is guided by the focus rails 51 to move only in the X axis direction along the focus rails 51. In that case, the moving optical system is driven by rotational driving force of a focus driving motor 46 to be described later.

The driving mechanism of the moving optical system is driving means for causing the whole moving optical system (42, 45) to move along the optical axis O of the moving optical system.

The driving mechanism of the moving optical system is configured with the focus driving motor 46, a focus decelerating mechanism 47, a focus rotational output shaft 48, a focus nut 49, an energizing spring 56, the moving optical system holding portion 59 and the like.

The focus driving motor 46 is a driving source for causing the moving optical system to move forward and backward in the X axis direction. The focus driving motor 46 is fixedly arranged on the second table 29Y which is a supporting member. In that case, a rotating shaft (not shown) of the focus driving motor 46 is arranged in the direction along the X axis.

The focus decelerating mechanism 47 is a component unit internally having a gear train or the like configured to decelerate in response to a rotational output from the rotating shaft of the focus driving motor 46. As for a configuration itself of the focus decelerating mechanism 47, it is assumed that a configuration similar to the configuration of conventionally well-known power decelerating means is applied, and detailed description of the configuration will be omitted. Note that the focus decelerating mechanism 47 is also fixedly arranged on the second table 29Y which is a supporting member.

The focus rotational output shaft 48 is a rotating shaft configured to output rotational force from the focus decelerating mechanism 47 and is formed, for example, in a feed screw shape. The focus rotational output shaft 48 couples the focus decelerating mechanism 47 with the focus nut 49 and plays a role of transmitting rotational driving force of the focus driving motor 46 to the focus nut 49.

The focus nut 49 is a driven member configured to move forward and backward in the X axis direction by a rotational output of the focus driving motor 46. The focus nut 49 is a component portion internally provided with a nut portion configured to be screwed with the feed-screw-shaped focus rotational output shaft 48 and fixedly arranged on the second table 29Y. The focus nut 49 is provided in a state of being movable in the X axis direction relative to the second table 29Y which is a supporting member.

Due to the configuration, when the focus rotational output shaft 48 (the feed screw) rotates in response to a rotational output of the focus driving motor 46, the focus nut 49 moves in the direction along the X axis by action of the nut portion screwed with the focus rotational output shaft 48. Here, the focus nut 49 (the driven member) is integrally combined with the moving optical system holding portion 59 (the holding portion). Thereby, when the focus nut 49 moves in the direction along the X axis, the moving optical system holding portion 59 (the holding portion) simultaneously moves in the same direction. Therefore, the moving optical system integrally held by the moving optical system holding portion 59 (the holding portion) also moves in the same direction. In this case, a rotation direction of the nut portion of the focus nut 49 is controlled by controlling a rotation direction of the focus driving motor 46, and, thereby, it is possible to control forward and backward movement directions of the moving optical system in the direction along the X axis direction.

Due to such a configuration, a focus potion is adjusted by causing the moving optical system to appropriately move forward or backward along the X axis direction, that is, the direction along the optical axis O by the driving mechanism which is driving means; and, at the time of causing the moving optical system to move in the direction along the optical axis O (the X axis direction), an angle of view of the moving optical system is constant, Therefore, as the image pickup optical system in the sample observation apparatus 1 of the present embodiment configured with the prism 41 and the moving optical system, a telecentric optical system is adopted as a whole.

The energizing spring 56 is an energizing member configured to energize the focus nut 49 in one direction relative to the second table 29Y (the fixation portion). One end and the other end of the energizing spring 56 are fixed to the focus nut 49 and the fixation portion of the second table 29Y, respectively. Therefore, the focus nut 49 is provided with a spring fixing shaft 50 configured to fix the one end of the energizing spring 56. Further, a spindle 52 configured to fix the other end of the energizing spring 56 is implanted in the fixation portion on the second table 29Y. In the present embodiment, an example of applying, for example, a coil spring having tautness as the energizing spring 56 is shown.

The light source portions 44 are arranged around the prism 41 on the second table 29Y. In the present embodiment, an example of arranging three light source portions 44 around the prism 41 is shown. The light source portions 44 are light source members configured to emit illumination light from below a sample in the culture vessel 13 placed on a predetermined part (the light transmitting portion 12a) on the lid 12 upward. As the light source portions 44, for example, illuminant bodies such as LEDs (light emitting diodes) are applied.

Note that, above the light source portions 44, that is, between the light source portions 44 and the light transmitting portion 12a of the lid 12, a light diffusing plate 53 is arranged. The light diffusing plate 53 is formed, for example, with a milky-white thin plate made of resin and having not only light transmissivity but also light diffusivity. The light diffusing plate 53 plays a role of causing illumination light emitted from the light source portions 44 to be diffused to illuminate an inside of the culture vessel 13 via the light transmitting portion 12a.

The illumination light emitted from the light source portions 44 enters the culture vessel 13 by being transmitted through the light transmitting portion 12a and the transparent bottom face of the culture vessel 13 as indicated by arrows L in FIG. 15. Such a configuration is made that the illumination light incident into the culture vessel 13 is transmitted through a sample existing in a medium 200 in the culture vessel 13 after being reflected by a reflective surface 13a inside the culture vessel 13 and enters the prism 41 via the light transmitting portion 12a.

The electric substrate 62 is fixedly arranged on the undersurface side of the second table 29Y, that is, on a surface on an opposite side of a side where the light source portions 44 are provided, near a position where the light source portions 44 are arranged. The electric substrate 62 is formed with a plurality of electric members 62a and the like, and a driving circuit for the light source portions 44, a driving circuit for the driving mechanism of the moving optical system, a driving circuit for the image pickup portion 43, an image signal processing circuit for image data outputted from the image pickup device 43a, and the like are implemented.

Further, the electric substrate 62 may be configured including, for example, a communication circuit for performing communication with external equipment, a data recording circuit including a recording medium for recording acquired image data, accompanying various kinds of information data and the like, and a power supply circuit including a battery for driving the focus driving motor 46, in addition to the circuits described above.

A connecting line 63, a lead wire 64 (see FIG. 11) and the like extend from the electric substrate 62, and end portions of the lead wire, a flexible printed-circuit board and the like are connected to the light source portions 44, (the focus driving motor 46 of) the driving mechanism, the image pickup substrate 43b of the image pickup portion 43, and the like. Furthermore, a connecting line 61 such as a different connecting cable and a flexible printed-circuit board extend from the electric substrate 62. The different connecting line 61 is connected to the electric boards 54, 55 (see FIG. 15) fixedly arranged on a fixation portion in the case 10. In this case, the connecting line 61 extends from the driven unit 60 which is a moving member configured to move within the X-Y plane. Therefore, length dimensions of the connecting line 61 are set with a margin so that movement within the X-Y plane can be absorbed.

Note that each of the light source portions 44, the prism 41 (the optical element) and the moving optical system holding portion 59 (the holding portion) is arranged so that predetermined intervals are given among them. Here, as the predetermined intervals, an interval indicated by reference symbol D in FIG. 13 is specified. The interval D is a movement range required for the moving optical system to move for focus adjustment.

Note that, as described above, the light source portions 44, the prism 41 (the optical element) and the driving mechanism constituted by the focus driving motor 46 and the like are fixedly arranged on the second table 29Y. Further, the focus rails 51 are also arranged on the second table 29Y, and the focus rails 51 are slidably held by the focus rail holding portions 59a of the moving optical system holding portion 59. Therefore, due to such a configuration, the second table 29Y functions as a supporting member configured to support (the moving optical system supported by) the moving optical system holding portion 59 in a state of being movable in the X axis direction.

As described above, according to the one embodiment described above, the sample observation apparatus 1 provided with the driving mechanism capable of causing the image pickup unit 40 having the optical system (42, 45) capable of performing focus adjustment and the image pickup device 43a to linearly move in each of two directions of the X axis and the Y axis orthogonal to each other and causing the image pickup unit 40 to freely move within a plane parallel to the X-Y plane, and configured to observe a sample in the culture vessel 13, the culture vessel 13 being arranged on the placing portion 12 having the light transmitting portion 12a is configured being provided with: the prism 41 (an optical element) configured to reflect light transmitted through the sample; a moving optical system (42, 45) including the image pickup device 43a and configured to move in the direction along the optical axis O to cause the light from the prism 41 (the optical element) to be image-formed on the image pickup surface of the image pickup device 43a; and the driving means (46 to 52, 59) configured to cause the whole moving optical system (42, 45) to move along the optical axis O of the moving optical system (42, 45).

The image pickup optical system constituted by the prism 41 (the optical element) and the moving optical system (42, 45) is configured forming a telecentric optical system as a whole.

As for the telecentric optical system, though it has been described that focus adjustment is performed by causing the whole moving optical system (42, 45) to move in a state of a constant magnification, it is also possible to make a zoom magnification changeable before performing focus adjustment if the telecentric state is maintained. In this case, it is possible to change the zoom magnification without causing the lenses in the moving optical system (42, 45) to move, that is, without changing the whole length of the moving optical system (42, 45), or it is possible to arrange the lenses at end portions of the moving optical system (42, 45), respectively, so that the zoom magnification can be changed by moving the lenses, though the whole length of the moving optical system (42, 45) becomes long.

Further, a configuration is made so that the focus position is adjusted by moving the moving optical system by the driving means, and the angle of view is constant at the time of causing the moving optical system to move in the direction along the optical axis O.

Due to such a configuration, it is possible to certainly perform focus adjustment for a sample such as cells, which is an observation target object, in the sample observation apparatus 1 of the present embodiment. At the same time, it is possible to obtain a favorable high-quality observation image without distortion in the sample observation apparatus 1.

Note that, though a configuration example is shown in which the driving force transmitting mechanism of one driving motor (the first driving motor 21X) is a belt driving system, and the driving force transmitting mechanism of the other driving motor (the second driving motor 21Y) is a feed screw driving system in the one embodiment described above, the present invention is not limited to the form.

For example, both of the driving force transmitting mechanisms of the two driving motors can be configured with feed screw driving systems. In that case, by devising to use means for converting a driving force output direction using a bevel gear or the like for a driving output of one rotating shaft, operation and effects similar to operation and effects of the one embodiment described above can be obtained.

Therefore, it is a main point to arrange the respective rotating shafts of the two driving motors to be parallel to each other irrespective of the driving systems of the driving force transmitting mechanisms for transmitting rotational driving force of the two driving motors.

Note that the present invention is not limited to the embodiment described above, and it is, of course, possible to perform various modifications and applications within a range not departing from the spirit of the invention. Furthermore, the embodiment described above includes inventions at various stages, and various inventions can be extracted by appropriate combination of a plurality of disclosed constituent features. For example, even if some constituent features are deleted from all constituent features shown in the one embodiment described above, a configuration obtained after deleting the constituent features can be extracted as an invention if the problem to be solved by the invention can be solved, and the advantageous effects of the invention can be obtained. Furthermore, components of different embodiments may be appropriately combined. The present invention is only limited by accompanying claims and not restricted by a particular practiced aspect of the invention.

What is claimed is:

1. A sample observation apparatus for observing a sample in a culture vessel, the culture vessel being arranged on a placing portion having a light transmitting portion, and the sample observation apparatus comprising:
an optical element configured to reflect light transmitted through the sample;
a moving optical system comprising an image pickup device and configured to move in a direction along an optical axis to cause the light from the optical element to be image-formed on an image pickup surface of the image pickup device; and
driving means configured to cause an whole of the moving optical system to move along the optical axis of the moving optical system; wherein
the optical element and the moving optical system form a telecentric optical system as a whole, and are configured to adjust a focus position by causing the moving optical system to move by the driving means and configured so that, at the time of causing the moving optical system to move in the direction along the optical axis, an angle of view is constant.

2. The sample observation apparatus according to claim 1, further comprising a light source portion arranged around the optical element and configured to emit illumination light from downward to upward of the sample; wherein
the light transmitted through the sample is light obtained by the illumination light being reflected by the culture vessel.

3. The sample observation apparatus according to claim 2, further comprising:
a holding portion configured to hold the moving optical system; and
a supporting member configured to fix the light source portion and the optical element and movably support the holding portion; wherein
the light source portion, the optical element and the holding portion are respectively arranged at predetermined intervals.

4. The sample observation apparatus according to claim 1, wherein
the driving means comprises a driving motor fixedly arranged on the supporting member and a driven member configured to move by a rotational output of the driving motor; and
the holding portion and the driven member are integrally combined.

5. The sample observation apparatus according to claim 1, wherein the optical element is a prism.
